(19) United States
(12) Patent Application Publication
(10) Pub. No.: US 2010/0053494 A1
(43) Pub. Date: Mar. 4, 2010

(54) LIQUID CRYSTAL DISPLAY DEVICE

(76) Inventors: Hung-Chun Li, Taoyuan County (TW); Ming-Chang Lin, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/268,456

(22) Filed: Nov. 11, 2008

(30) Foreign Application Priority Data
Aug. 29, 2008 (TW) 097215597

(51) Int. Cl. G02F 1/1333

(52) U.S. Cl. 349/60

(57) ABSTRACT

A LCD device includes an illumination device generating heat, a side frame including a recess for fixing the illumination device, a LCD panel fixed to the side frame and a resilient heat-conductive element accommodated in the recess and contacting the illumination device and the LCD panel.

### BACKGROUND OF THE INVENTION

1. Field of the Invention

The present invention relates to a liquid crystal display (LCD) device. In particular, the present invention relates to a LCD device with less warm-up time.

2. Description of the Prior Art

The liquid crystal device (LCD) has replaced the traditional ray tube (CRT) to be one of the indispensable electronic devices of our daily lives and has been a huge success commercially. The liquid crystal device has many advantages over the traditional ray tube, such as a smaller dimension, larger in size and higher brightness. Also, the liquid crystal device can be used both interiorly and exteriorly. However, the optical properties of the liquid crystal device are seriously influenced by the panel temperature. According to various researches, the viscosity of the liquid crystal molecular is adversely proportional to the panel temperature. Such relationship renders the obvious dynamic ghost shadow of the liquid crystal device due to the high viscosity under relatively lower temperature, such as from cold turn-on or in a colder surrounding. The obvious dynamic ghost shadow causes the users trouble. Generally speaking, the dynamic ghost shadow begins to fade away in accordance with the lowering of the viscosity after the liquid crystal device has been running for tens of minutes, and eventually the presentation of the images reaches a steady state. The time duration from the initiation to reaching a steady state is called the warm-up time. There are many known techniques for the improvement of the presentation of the images by shorting the warm-up time.

For example, U.S. Pat. No. 7,023,519 provides an ITO heater for a liquid crystal display. When the surrounding temperature is too low, some heat has to be pumped in to bring the temperature of the device to a reasonable value. Please refer to FIG. 1, illustrating the heater for a liquid crystal display. The heater 1 includes a transparent conductive layer 4 disposed between the electrodes 5 and the extensions 6. Thus the electrodes 5 have extensions 6 for connection directly or by wires with a source of alternating applied voltage, in order to actuate the heater to produce heat. The electrodes 5 are substantially parallel to provide for uniform heat distribution. In this liquid crystal display, an additional device, i.e. the heater 1, is introduced. After the liquid crystal device is turned on, the additional heater 1 provides additional thermal energy in order to shorten the warm-up time by speeding up the raise in temperature of the liquid crystal panel. However, such technical solution is still flawed. First, such device is additionally introduced. This additional device not only raises the cost of production but also makes the production line more complicated. Second, the additional device increases the total thickness of the device and adversely affects the dimensional shrinkage of the entire device. Still, the device consumes additional energy to generate the needed heat, which is not very environmentally friendly.

Accordingly, a novel liquid crystal display panel is needed to shorten the warm-up time. Such liquid crystal display panel in one aspect should not only maintain an ideal thickness of the liquid crystal display but also no additional energy should be consumed in order to speed up the warm-up time.

### SUMMARY OF THE INVENTION

The present invention therefore proposes a novel liquid crystal display panel with shorter warm-up time. The advantages of the liquid crystal display panel of the present invention lies in the shorter warm-up time without consuming additional energy in order to speed up the warm-up time. In addition, the liquid crystal display panel of the present invention with shorter warm-up time maintains the ideal thickness of the liquid crystal display, too.

The present invention first provides a liquid crystal device. The liquid crystal device includes an illumination device generating heat, a side frame including a recess for fixing the illumination device, a liquid crystal device panel fixed to the side frame and a resilient heat-conductive element accommodated in the recess and contacting the illumination device and the LCD panel.

The present invention further provides another liquid crystal display device. The liquid crystal display device of the present invention includes a backlight module (BLM) which generates heat, a liquid crystal display panel disposed on the backlight module, a housing for fixing the liquid crystal display panel and the backlight module and at least one resilient heat-conducting element for selectively conducting the heat generated from the backlight module toward the liquid crystal display panel.

The present invention employs the wasted heat of the light source device as the heat source to heat up the liquid crystal display panel. This ingenious design not only reduces the total energy consumption of the liquid crystal device to meet the demand of the global issue of being “environmentally friendly”, but also solves the dissipation problem of the wasted heat from the light source device to expect a longer operational life time. Furthermore, because there is no extra part which may adversely affect the total thickness of the liquid crystal device, the liquid crystal display device of the present invention may maintain an ideal thickness, too. Moreover, the liquid crystal display panel of the present invention includes no additional device to raise the cost of production or to make the production line more complicated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the heater for a liquid crystal display.

FIG. 2-5 illustrate preferred embodiments of the liquid crystal display panel of the present invention.

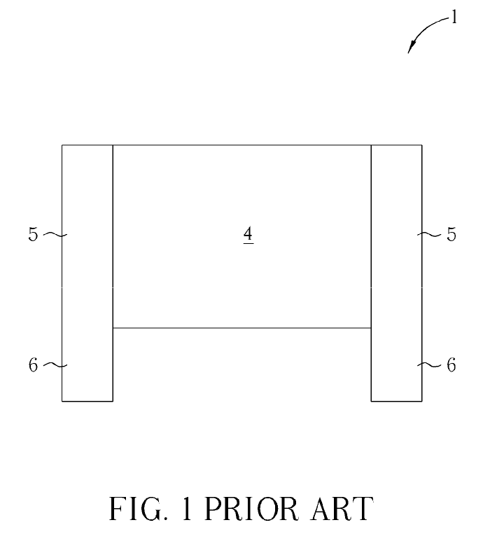

### DETAILED DESCRIPTION

The present invention provides a novel liquid crystal display panel. The liquid crystal display panel of the present invention has shorter warm-up time by employing the wasted heat of the illumination device as the heat source to heat up the liquid crystal display panel. The liquid crystal display panel of the present invention solves the dissipation of the wasted heat from the illumination device to expect a longer operational life time because of an ingenious design to reduce the total energy consumption of the liquid crystal device to meet the demand of the global issue of being “environmentally friendly” by employing the wasted heat of the illumination device as the heat source to heat up the liquid crystal display panel. Furthermore, because there is no extra part which may adversely affect the total thickness of the liquid crystal device, the liquid crystal display panel of the present invention may maintain an ideal thickness, too. Moreover, the liquid crystal display panel of the present invention includes no additional device to raise the cost of production or to make the production line more complicated.

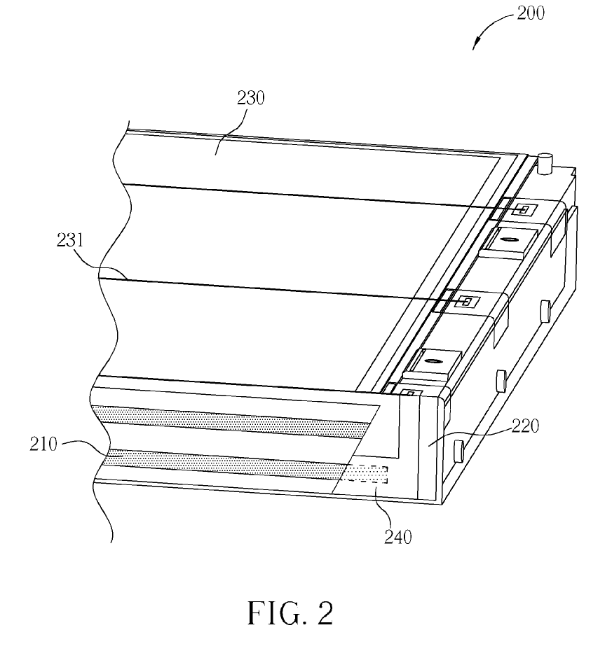

FIG. 2 illustrates a preferred embodiment of the liquid crystal display panel of the present invention. The liquid crystal display device 200 of the present invention includes a light source device or an illumination device 210, a side frame 220, a liquid crystal display panel 230 and a resilient heat-conducting element 240. The liquid crystal display panel 230 of the liquid crystal display device 200 of the present invention may be various display panels which need a back light, such as TFT LCD panel or color super-twist nematic, CSTN.

The light source device 210 starts to generate heat once turned on. The regular liquid crystal display device is equipped with an additional heat-dissipating module to avoid the accumulation of the wasted heat. A back light module (BLM) may include the light source device 210 and the side frame 220. The light source device 210 may include a light source and an inverter to drive the circuit for the light source. Generally speaking, both the light source and the inverter generate heat. Suitable light sources for use in the light source device 210 may be, for example, the cold cathode fluorescent lamp (CCFL), the external electrode fluorescent lamp (EEFL) or the light emitting diode. The side frame 220 may further include at least one recess for fixing the light source device.

The housing is used for fixing the elements, for example the light source/the inverter of the light source device 210, the side frame 220, the liquid crystal display panel 230 and the resilient heat-conducting element 240. The housing may be a (side) frame and includes a plurality of recesses to fixate various elements of the back light module. In addition, the housing may further include other devices, such as a latch, to fixate various elements of the liquid crystal display device 200 of the present invention. The side frame 220 may be made of materials such as metal, plastics, or the combination thereof.

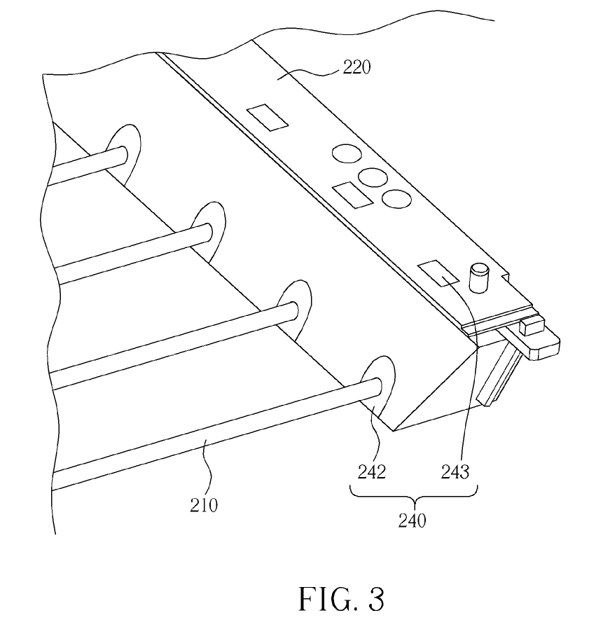

FIG. 3 illustrates a preferred embodiment of the resilient heat-conducting element accommodated in the recess of the side frame 220 of the liquid crystal display device of the present invention. Please refer to both the FIGS. 2 and 3; the resilient heat-conducting element 240 are in contact with the liquid crystal display panel 230 and the light source device 210, so that the wasted heat generated from the light source and the inverter of the back light module can be selectively conducted to the liquid crystal display panel 230. The liquid crystal molecular in the liquid crystal display device therefore gets additional thermal energy to lower its viscosity and to reduce the gray-to-gray response time, and further to eliminate the dynamic ghost shadow. In such way, the liquid crystal display device reaches the steady state as soon as possible.

The resilient heat-conducting element 240 is preferably resilient and conductive. In one aspect, elasticity keeps the light source device 210 from any damage and thermal conductivity renders the wasted heat selectively guided to the liquid crystal display panel 230. The resilient heat-conducting element 240 may include resin, rubber, plastics, silicone or the combination thereof. For example, the powdered thermal conductive material may be mixed with the resin, the rubber, the plastics or the silicone to make the resilient heat-conducting element 240 suitable for the present invention. Depending on the light source and the inverter, the liquid crystal display device 200 of the present invention may include at least one resilient heat-conducting element 240 so that the wasted heat generated from the back light module can be selectively conducted to the liquid crystal display panel 230.

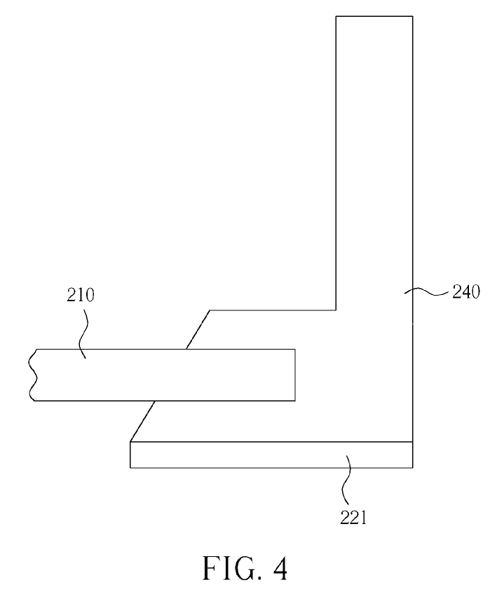

As shown in FIG. 4, in order to facilitate the resilient heat-conducting element 240 to conduct the wasted heat generated from the light source device 210, in one preferred embodiment of the present invention, the housing/the side fame 220 may further include a control heat-conductive element, such as a thermal insulating material 221, to help the resilient heat-conducting element 240 to selectively conduct the wasted heat generated from the back light module to the liquid crystal display panel 230. The suitable thermal insulating material may be plastics or rubber.

On the other hand, in another preferred embodiment of the present invention, a thermal conductive element 231 is on the liquid crystal display panel 230, as shown in FIG. 2, for uniform heat distribution. Suitable thermal conductive element 231 may be metal or a transparent thermal conductive material integrated in the liquid crystal display panel manufacturing process.

When the resilient heat-conducting element 240 conducts the wasted heat to the liquid crystal display panel 230 after the light source device 210 is turned on, the decreased speed of the viscosity of the liquid crystal molecular in the liquid crystal display panel is accelerated and the liquid crystal display device 200 enters the steady state sooner to dramatically cut down the warm-up time. Preferably, the liquid crystal display panel 230 of the present invention may reach a steady state of 40° C.-80° C. with several minutes. For example, the temperature of the CCFL may further drop to about 78° C. from about 98.3° C.

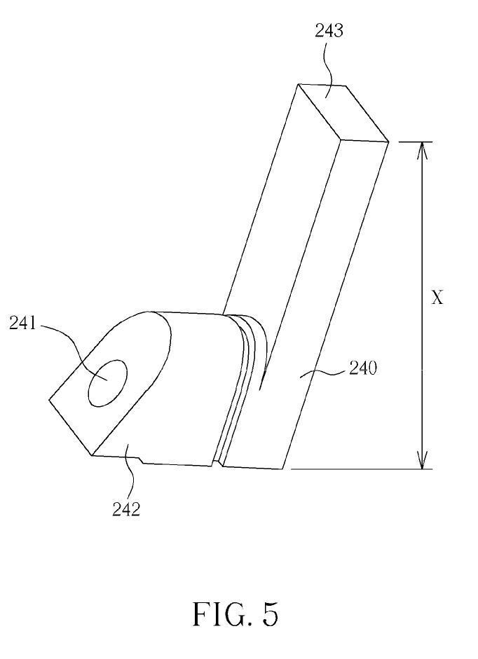

Please refer to FIG. 5, illustrating a preferred embodiment of the shape of the resilient heat-conducting element 240. The resilient heat-conducting element 240 accommodated in the side frame 220 may be in an L shape. Besides, the resilient heat-conducting element 240 may further include a recess 241 to accommodate the light source device 210, a heat-conducting region 242 contacting the light source device 210 and a heat-dissipating region 243 contacting the liquid crystal display panel 230, as illustrated in FIG. 3, too. Preferably, the thickness X of the heat-dissipating region 243 is between 1.5 cm to 3 cm, depending on the thickness of the side frame 220 and slightly protrudent from the top side of the side frame 220 and in contact with the liquid crystal display panel 230 to keep an ideal thickness of the liquid crystal display device 200 of the present invention as thin as possible.

Those skilled in the art will readily observe that numerous modifications and alterations of the device and method may be made while retaining the teachings of the invention.

What is claimed is:

1. A liquid crystal device, comprising:
a backlight module;
a liquid crystal display panel disposed on said backlight module;
a housing for fixing said liquid crystal display panel and said backlight module; and
at least one resilient heat-conducting element for selectively conducting the heat generated from said backlight module toward said liquid crystal display panel.

2. The liquid crystal device of claim 1, wherein said backlight module comprises a light source device and a side frame.

3. The liquid crystal device of claim 2, wherein said resilient heat-conducting element is accommodated in a recess of said side frame and contacting said liquid crystal display panel and said light source device.

4. The liquid crystal device of claim 2, wherein said light source device comprises a light source and an inverter.

5. The liquid crystal device of claim 4, wherein said light source is selected from a group consisting of a cold cathode fluorescent lamp (CCFL), an external electrode fluorescent lamp (EEFL) or a light emitting diode.

6. The liquid crystal device of claim 1, wherein said housing comprises a heat-insulating element to facilitate said resilient heat-conducting element to selectively conduct the heat generated from said backlight module toward said liquid crystal display panel.

7. The liquid crystal device of claim 1, wherein said liquid crystal display panel further comprises a heat-conducting element to uniformly conduct the heat generated from said backlight module.

8. The liquid crystal device of claim 1, wherein said liquid crystal display panel has a steady state temperature of 40° C.-80° C.

9. The liquid crystal device of claim 1, wherein said resilient heat-conducting element is L-shaped.

10. The liquid crystal device of claim 1, wherein said resilient heat-conducting element comprises a heat-conducting region contacting said backlight module and a heat-dissipating region contacting said liquid crystal display panel.

11. The liquid crystal device of claim 10, wherein the thickness of said heat-conducting region is of 1.5 cm to 3.0 cm.

12. The liquid crystal device of claim 1, wherein said resilient heat-conducting element is selected from a group consisting of resin, rubber, plastics, and silicone.
